(19) United States
(12) Patent Application Publication
(10) Pub. No.: US 2017/0293890 A1
(43) Pub. Date: Oct. 12, 2017

(54) CONTEXTUAL WORKFLOW MANAGEMENT

(71) Applicant: Bizagi Group, Misda (MT)

(72) Inventors: Jesús Orlando Sanchez Merchan, Bogotá (CO); Gustavo Ignacio Gomez Gonzalez, Buckinghamshire (GB); Marcel Josef Manser Sonderer, Chia Cundinamarca (CO); Diego Enrique Parra Leaf, Chia Cundinamarca (CO); Anwar Saud Hussein Ibanez Okamell, Bogotá (CO); José Alcides Aranzazu Montoya, La Calera Cundinamarca (CO)

(21) Appl. No.: 15/515,737

(22) PCT Filed: Aug. 26, 2015
(86) PCT No.: PCT/EP2015/069560

§ 371 Date: Mar. 30, 2017

(30) Foreign Application Priority Data
Sep. 30, 2014 (GB) 1417262.1

(51) Int. Cl. G06Q 10/10; G06Q 10/06; G06Q 50/22

(52) U.S. Cl. CPC G06Q 10/103; G06Q 50/22; G06Q 10/06

(57) ABSTRACT

A computer system for enforcing a workflow, the computer system comprising: a computer store comprising: a set of actions; a plurality of data objects each comprising a specification identifying one or more of the set of actions for operation on the data object; and a plurality of stakeholder objects each being associated with (a) one or more of the data objects and (b) one or more of the set of actions; a user terminal coupled to the computer store and configured to provide a user with access to one or more data objects associated with a stakeholder object corresponding to that user; and a computer processor configured perform at least part of a workflow comprising a sequence of first and second actions by: operating a first action of the set on a first data object of the plurality; in response to a first user accessing the first data object at the user terminal, causing the user terminal to present to the first user one or more second actions identified by the first data object and associated with a first stakeholder object corresponding to the first user; and on the first user selecting a second action at the user terminal, operating the selected second action on the first data object.

### BACKGROUND OF THE INVENTION

This invention relates to a computer system for enforcing a workflow. The invention is not directed to workflows as such but to a technically improved computer system suitable for implementing a workflow.

Computer systems for workflow management are crucial to the efficient operation of businesses and organisations around the world. Many business use computer systems to define and organise processes which are to be followed by their personnel. Particularly in large organisations with workers spread over many sites or even countries, this can help to ensure that processes are consistently and efficiently performed throughout the business. For example, in service industries such as insurance or banking, the use of workflow management systems can ensure that a minimum quality of service is provided by the business to their customers. Workflow management may also be referred to as business process management (BPM).

Conventional computer systems for workflow management are good at defining prescriptive business processes, such as the kind of business processes which might be followed by the administrative employees of a bank or insurance company. In such circumstances it can be desirable for the employees to follow a defined workflows with a view to ensuring that appropriate letters are sent out to the customer at the appropriate times and that every case handled by the employees is subject to all of the required checks and authorisations by the appropriate members of staff.

An example of a workflow defined by a conventional workflow management system operated by a large bank is shown in FIG. 1. The system is provided as software through which the bank's employees are required to perform their duties. In this example, workflow 100 is performed in order to approve a loan request received from a customer. The loan request is received at the bank by any one of a number of loan clerks who generate a new case 101 representing the loan request and initiate the workflow. The clerk would typically enter information from the loan request into the case, although some information could be imported from other records (e.g. bank account records) held by the bank if the customer already makes use of the bank. Once the mandatory fields of the new case are complete and the clerk marks the case as done, the system moves the case onto the next step in the workflow for handling by one of the bank's loan processors. At this point, the case will appear in a list of cases available for the bank's loan processors to work on. One of the loan processors opens the case and processes the loan request 102 by performing a series of checks on the loan request, such as checking the credit history of the customer and verifying their identity. The results of the checks are stored in the case and the system moves the case on to a bank manager for approval.

The bank manager will receive the case in their list of cases for approval at step 103, which involves the bank manager reviewing the case in the system, including the results of the checks. If the bank manager rejects the loan request, the system moves the case back to a loan clerk for a rejection letter to be sent to the customer 104. If the bank manager approves the loan request, the system moves the case to a finance clerk for payment of the loan 105 by a finance clerk and the issuance of an approval letter. The workflow terminates at step 105 or 106 depending on the decision of the bank manager at step 103.

The system enforcing workflow 100 is configured to ensure that the steps carried out by the various employee groups of the bank are performed according to a defined workflow for handling loan requests: the steps are performed in order, with each step being performed by a predetermined employee group, and only once the previous step has been completed. This might be appropriate for the workflow illustrated in FIG. 1 but for other more complex workflows, especially those in which skilled workers are involved, a greater degree of flexibility can be required which is difficult to achieve in conventional systems.

In conventional computer systems for workflow management, workflows are predefined in the system by linking together actions stored at a database so as to define workflows between predetermined start and end points. Each action represents a predefined step in a workflow (e.g. generating or updating a case in the example shown in FIG. 1). This approach works well for low-skilled workers (e.g. call centre workers) repetitively performing a limited number of tasks, but it has significant limitations if applied to skilled workers (e.g. doctors, lawyers and other professionals) who must retain a considerable degree of decision-making ability.

In conventional workflow management systems, in order to enforce workflows for skilled workers it is necessary taking the above approach to define a very large number of workflows in the database covering the range of possible workflows which could be performed by the workers. This leads to an excessive processing overhead, high storage requirements and poor performance at the system, as well as placing a high burden on the initial configuration of the system in terms of defining each of the possible workflows.

In some computer systems it is possible to assemble workflows by aggregating defined workflow fragments. This allows workflow fragments to be re-used across different processes and so can help to mitigate some of the performance issues when a conventional system is configured to enforce workflows in a complex environment. However, the storage and processing burden on a system configured to operate with skilled professionals, who at any given step in a process could make one of a large number of decisions, can still be excessive.

### BRIEF SUMMARY OF THE INVENTION

According to a first aspect of the present invention there is provided a computer system for enforcing a workflow, the computer system comprising:
a computer store comprising:
   a set of actions;
   a plurality of data objects each comprising a specification identifying one or more of the set of actions for operation on the data object; and
   a plurality of stakeholder objects each being associated with (a) one or more of the data objects and (b) one or more of the set of actions;
a user terminal coupled to the computer store and configured to provide a user with access to one or more data objects associated with a stakeholder object corresponding to that user; and
a computer processor configured perform at least part of a workflow comprising a sequence of first and second actions by:
   operating a first action of the set on a first data object of the plurality;
   in response to a first user accessing the first data object at the user terminal, causing the user terminal to present to the first user one or more second actions identified by the first data object and associated with a first stakeholder object corresponding to the first user; and
   on the first user selecting a second action at the user terminal, operating the selected second action on the first data object.

The first and second actions may not be linked at the computer system so as to define the workflow.

The computer processor may be configured to:
in response to a second user accessing the first data object at the user terminal, cause the user terminal to present to the second user one or more first actions identified by the first data object and associated with a second stakeholder object corresponding to the second user; and
operate said first action on the first data object in response to the second user selecting that first action at the user terminal.

The computer system may be configured to authenticate the first user at the user terminal and, in dependence on that authentication, identify the corresponding stakeholder object at the computer store.

The computer store may further comprise one or more user profiles each indicating a stakeholder object, the computer system being configured to identify the corresponding stakeholder object at the computer store by, in dependence on credentials provided by the user, looking up the user profile for that user and using the indicated stakeholder object as the corresponding stakeholder object.

The access of the first data object by the first user at the user terminal may comprise one or more of:
performing a search for information held at the first data object;
browsing information held at the first data object; and
selecting information held at the first data object and presented at the user terminal.

The computer processor may be configured to present the one or more second actions at the user terminal as selectable options.

The computer processor may be configured to perform the first and second actions on the first data objects in accordance with procedural data held at the respective actions.

The first or second actions may be configured to modify the first data object and/or create a new instance of the first data object using information from the first data object.

One or more of the plurality of data objects may further include a context for one or more of the actions identified therein, each context defining a set of one or more characteristics of the respective data object required for triggering the action, and the computer processor being further configured to present to the first user only those of the one or more second actions whose context is satisfied by the first data object.

At least some of the set of actions may include preconditions specifying information required by the action, and the computer processor being configured to automatically use in the selected second action the specified information as derived from the first data object.

The computer processor may be configured to permit the first user to access only those one or more data objects associated with a stakeholder object corresponding to the first user.

The user terminal may be configured in dependence on configuration data held at the stakeholder object corresponding to the first user.

The computer processor and computer store may be provided at a computer server coupled to the user terminal.

According to a second aspect of the present invention there is provided a method for enforcing a workflow at a computer system defining a set of actions, a plurality of data objects each comprising a specification identifying one or more of the set of actions for operation on the data object, and a plurality of stakeholder objects each being associated with (a) one or more of the data objects and (b) one or more of the set of actions, the method comprising:
operating a first action of the set on a first data object of the plurality;
permitting a first user to access one or more of the data objects associated with a first stakeholder object, the one or more data objects including the first data object;
in response to the first user accessing the first data object, presenting to the first user one or more second actions identified by the first data object and associated with the first stakeholder object; and
on the first user selecting a second action, operating the selected second action on the first data object.

According to a third aspect of the present invention there is provided a computer system for enforcing a workflow, comprising:
a database comprising:
   stakeholder objects each specifying a set of data objects associated with a stakeholder; and
   a plurality of data objects each having a specification identifying one or more predefined actions for operation on the data object and stakeholders permitted to initiate each of those actions;
a computer interface adapted for accessing the data objects; and
a computer processor is configured to:
   in response to a stakeholder accessing one or more of their associated set of data objects, present actions at the computer interface for selection by a stakeholder in accordance with the specifications of the accessed data objects; and
   in response to a stakeholder selecting one of the presented actions, perform that action on the accessed data objects.

The computer processor may be configured to present said actions at the interface in response to the stakeholder accessing their associated set of data objects by one or more of:
performing a search at the interface for information held at their data objects;
browsing at the interface information held at their data objects; and
selecting information held at their data objects and presented at the interface; the accessed data objects being the data objects holding said information.

The computer processor may be configured to present said actions in response to the stakeholder browsing information held at their data objects and selecting a subset of that information, said actions being identified by the computer processor in dependence on the selected information and not the unselected information.

Each action may include procedural data representing the processes to be performed by the computer processor.

The procedural data may specify a configuration of the computer interface and/or data processing to be performed by the computer processor.

The computer processor may be further configured to, perform the selected action on one or more of the accessed data objects in accordance with procedural data held at the action.

The selected action may be so as to modify the one or more of the accessed data objects and/or create a new instance of a data object using information from one or more of the accessed data objects.

The specifications of the data objects and the stakeholder objects may be configured such that a sequence of actions representing a workflow can be performed by stakeholders accessing their respective sets of data objects and initiating actions presented to them at the interface.

The specifications of one or more of the accessed data objects may include a context for one or more of their identified actions, each context defining a set of one or more characteristics of the respective data object for triggering the action, and the computer processor being further configured to present to the stakeholder only those actions whose context is satisfied by the accessed data objects.

At least some of the actions may include preconditions specifying information required by the action and held at the data objects, and the computer processor being configured to automatically use in an initiated action the specified information as derived from the accessed data objects.

The computer processor may be configured to permit the stakeholder to access only those data objects with which it is associated.

The interface may be configured to allow the stakeholder to browse and/or search information held at the data objects, the computer processor being configured to restrict said information to information held at the set of data objects associated with the stakeholder.

The interface may be configured in dependence on configuration data held at the stakeholder object for the stakeholder.

The stakeholder may be represented by a user of the system associated with a stakeholder object.

The system may comprise a profile for the user identifying one or more stakeholders represented by the user.

The data objects may be logically defined at one or more tables held at a database of the system.

The actions may not be linked so as to predefine a workflow.

The system may not define workflows as predefined sequences of actions.

The computer processor may comprise one or more of a processor at a server and a processor at a user terminal supporting the computer interface.

According to a fourth aspect of the present invention there is provided a computer system for enforcing a workflow, comprising:
a database that includes:
   a plurality of stakeholder objects each defining a stakeholder and identifying data objects associated with that stakeholder;
   a plurality of data objects each holding respective object information and identifying one or more actions for operation on the data object and the stakeholders permitted to select those actions; and
   a plurality of actions for operation on the data objects;
an interface for providing a user of the system access to object information held at the data objects; and
a computer processor operable to perform the actions on the data objects and being configured to:
   at the interface, allow the user to access object information held at those data objects associated with one or more stakeholders represented by the user; and
   in response to the user accessing object information at the interface, present to the user actions which are identified at said those data objects as (a) being for operation on the subject data objects, and (b) which at least one of the one or more stakeholders represented by the user is permitted to select.

According to a fifth aspect of the present invention there is provided a method for enforcing a workflow at a computer system having a database comprising stakeholder objects each specifying a set of data objects associated with a stakeholder, and a plurality of data objects each having a specification identifying one or more actions for operation on the data object and stakeholders permitted to initiate each of those actions, the method comprising:
identifying a user of the system as a stakeholder;
permitting the user to access one or more of the set of data objects associated with the stakeholder at their stakeholder object;
in response to the user accessing one or more of the set of data objects, presenting actions to the user in accordance with the specifications of the one or more accessed data objects; and
in response to the user selecting a presented action, performing the selected action on one or more of the accessed data objects in accordance with procedural data predefined at the system for the action.

The method may further comprise causing one or more users representing a plurality of different stakeholders to access their associated data objects and each select a presented action such that, collectively, the plurality of stakeholders perform a sequence of actions representing a workflow.

There is provided computer program code for performing a method as described herein. There is provided a non-transitory computer readable storage medium having stored thereon computer readable instructions that, when executed at a computer processor, cause the computer processor to perform the method as described herein.

### BRIEF DESCRIPTION OF THE DRAWINGS

The present invention will now be described by way of example with reference to the accompanying drawings. In the drawings:

FIG. 1 shows a conventional workflow management system.

FIG. 2 shows a workflow management system configured according to the principles described herein.

FIG. 3 illustrates an exemplary structure of the database of FIG. 2.

FIG. 4 illustrates a user interface of a terminal of FIG. 2.

FIG. 5 shows an example of a workflow performed at the system of FIG. 2.

FIG. 6 shows an example stakeholder object.

FIG. 7 shows an example data object.

FIG. 8 shows an example process definition.

FIG. 9 is a flowchart illustrating the operation of the workflow management system.

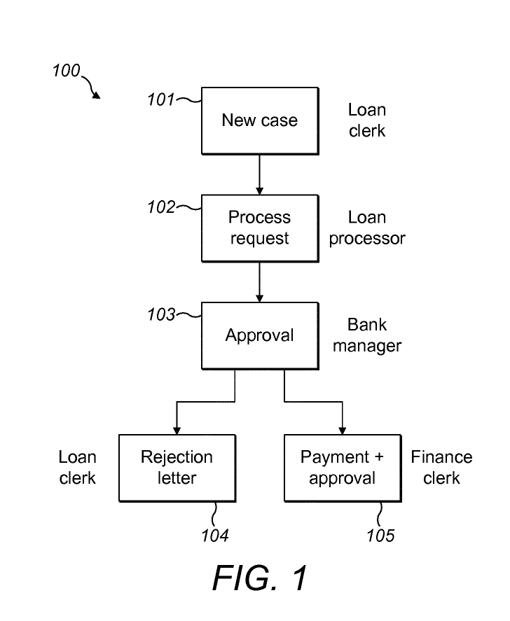

### DETAILED DESCRIPTION

The following description is presented by way of example to enable any person skilled in the art to make and use the invention. The present invention is not limited to the embodiments described herein and various modifications to the disclosed embodiments will be readily apparent to those skilled in the art.

In order to address limitations present in conventional systems, there is provided a computer system configured to permit complex workflows to be enforced whilst minimising the storage and processing requirements of the computer system. Workflows need not be predefined at the system and instead emerge from the particular configuration of the computer system. Each workflow represents a sequence of actions which a group of one or more users of the system can collectively follow. As is described below, sequences of actions which are not permitted cannot be performed by users of the system because at any given step in a workflow, invalid actions are not presented to a user. In this manner the computer system can restrict users to performing valid workflows. An exemplary configuration of a computer system for enforcing workflows and having the advantages described above will now be described.

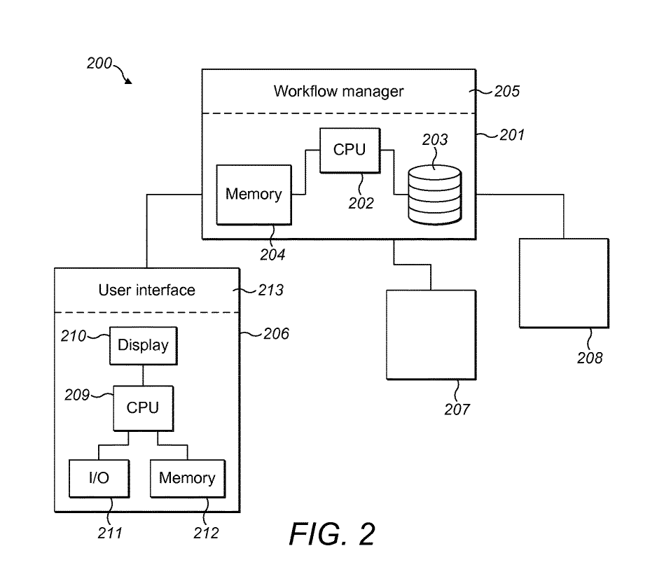

An example of a computer system for enforcing a workflow is shown in FIG. 2. In FIG. 2, computer system 200 comprises a computer server 201 having a processor 202, a memory 204 and a database 203. The database could be located at the server as shown in FIG. 2 or at a data store accessible to the server (e.g. over a network or the internet). The processor and memory support a workflow manager 205 which in this example is software arranged to operate on the data held at database 203 so as to allow users of computer terminals 206, 207 and 208 of the system to perform workflows.

There could be any number of terminals, but in this example there are three. The database could comprise one or more data stores distributed over the system, including locally at the server and/or at storage locations outside the server. The server could comprise one or more processing entities (e.g. processor cores, servers or blades on a blade server) with access to database 203 and supporting a workflow manager. The database may be a relational database, and associations between objects of the database may be represented by links between tables of the database.

Each of the computer terminals may be configured as shown for terminal 206 so as to include a processor 209, a display 210, an input/output unit 211 and a memory 212. The processor and memory support a user interface 213 with which a user of the terminal can interact with the computer terminal by means of input/output unit 211 (e.g. a keyboard, mouse, touchscreen etc.). Each terminal could be any kind of computing device, such as a desktop or laptop computer, a tablet or a smartphone. Each terminal could be a “thin” terminal which relies on the server to perform at least some of its processing, or a standalone computing device connected to server 201. It will be appreciated that many other configurations of computer server and terminal are possible.

The user interface 213 of a terminal presents the user with access to database 203. The user interface could provide a lightweight front-end (e.g. a web application providing the user interface 213) by means of which a user can interact with the workflow manager 205 which is configured to mediate access to the database 203 and substantially perform the processing required by a sequence of actions making up a workflow. In other examples, the user interface itself could include some or all of the workflow manager and hence perform some or all of the processing associated with a workflow. Many intermediate configurations are possible between these two exemplary extremes. The processors of the computer system (e.g. at the server and/or terminals) as configured by the workflow manager and/or user interface enforce workflows in accordance with the principles described herein.

One or more parts of database 203 could be located at the terminals as copies of part of the database which are accessible to the user interface at that respective terminal and/or by way of distributing at least some of the data of database 203 over the terminals of the system. The server could itself operate as a terminal by means of which a user can perform one or more steps of a workflow.

User interface 213 represents an example of a computer interface of the system 200 for providing users of the system access to data held at the database in the data objects. In other examples, the interface could be supported at the same processing entity as the workflow manager 205 and/or could be non-graphical, such as an application programming interface (API), web API, or similar. For instance, a workstation could comprise both a workflow manager and a user interface running at a processor, the workstation thus performing the functions of both server and terminal.

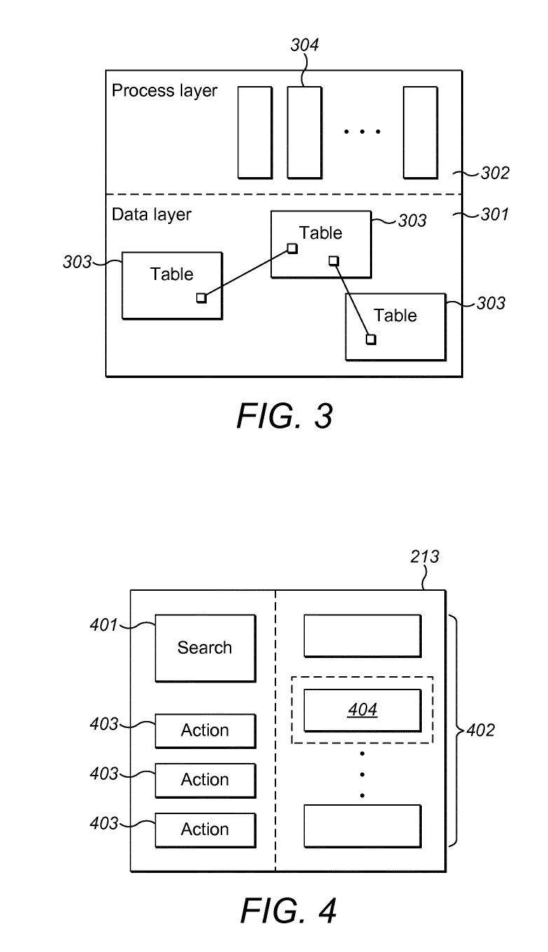

An example of the data held at database 203 is shown in FIG. 3. The database 203 may include a data layer 301 and a process layer 302. The data layer may include tables 303 defining a set of data objects and a set of stakeholder objects. The data objects and stakeholder objects may be linked so as to logically define for each stakeholder a set of data objects associated with that stakeholder. Each stakeholder object corresponds to a stakeholder role in the particular workflows which the computer system is configured to support. The tables may link to other data sources external to the database (e.g. data sources holding patient records, or contact details for the customers of a business). The process layer includes a set of process definitions 304 each of which specifies an action that can represent a step of a workflow. The process definitions may link to the tables in the data layer so as to reference the data and stakeholder objects, and vice versa. For example, the data objects may, by virtue of appropriate links from tables 303 to process definitions 304, identify actions permitted for operation on the data object and the stakeholders permitted to initiate each of those actions. The data and stakeholder objects, and the process definitions are described in more detail below. Other data structures able to define data and stakeholder objects and process definitions for use in the manner described herein may alternatively be used. The terms data layer and process layer may indicate logical groupings of data at a database and need not imply any corresponding structure of the database.

The workflow manager 205 is configured to operate in dependence on the data held at the database 203 so as to enforce workflows by constraining users of the computer terminals 206-208 to perform sequences of actions on data objects of the database in accordance with the permissions defined at the database. This may be achieved according to the following example.

A set of stakeholder objects are defined at the database 203, each defining a stakeholder in the workflows and the data objects which are associated with that stakeholder. Each stakeholder may represent a type of user of the system who is able to perform one or more actions at the system. For example, in a computer system configured to enable hospital staff to follows process in a hospital environment, the stakeholders may be the nurses, doctors and other hospital staff involved in performing actions at the system. Triage nurses might be one stakeholder, emergency room (ER) doctors a second stakeholder, and orthopaedic surgeons a third stakeholder. Each user of the system may belong to one or more stakeholders and there could be one or more users associated with each stakeholder.

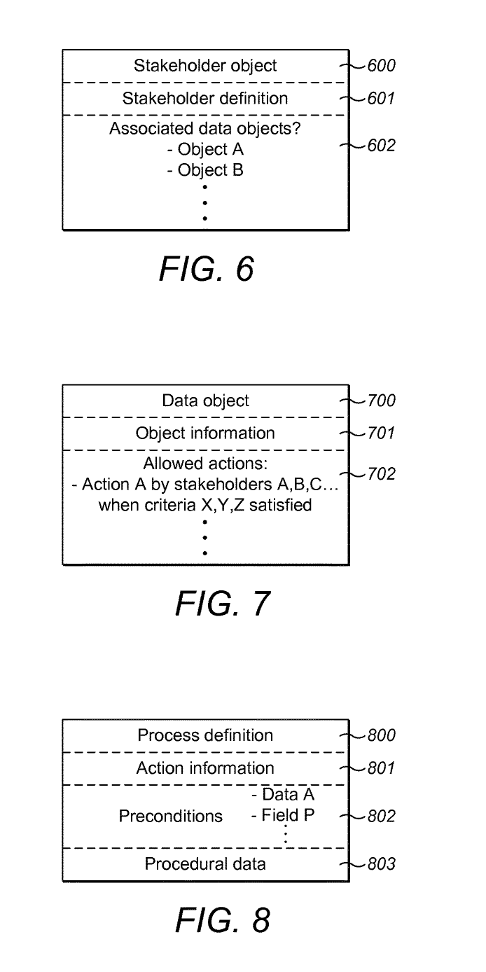

An example of the logical data content of a stakeholder object or definition 600 is shown in FIG. 6. The stakeholder object 600 includes a definition of the stakeholder 601, which might include information such as the name of that stakeholder and other characteristics. The stakeholder object may also include data 602 specifying the data objects associated with the stakeholder (e.g. the orthopaedic surgeon mentioned above might be associated with data objects representing surgical cases). In other examples, information specifying the data objects may be stored in any other manner—for example, by linking the stakeholder object to its associated data objects, or storing such associations at specification data held at the database. A stakeholder object could include data defining one or more configurations of the user interface for the stakeholder—for example, the stakeholder object could define a configuration (e.g. appearance, arrangement of presented data, ability to browse data, and/or search data) of user interface 213 appropriate to the role performed by that stakeholder.

A set of data objects may be defined at the database 203, each data object including data for that object. Data at the data object may identify one or more actions which can be performed on that object and/or this may be defined through appropriate linking of the data object to actions held at the process layer. Each data object may further specify which stakeholders are permitted to run each of the actions which can be performed on the data object and/or this may be defined through appropriate linking of the data object to stakeholder objects held at the data layer. For example, in the workflow management system modelling workflows in a hospital, the data objects could be patient records, represent an investigation (e.g. an X-Ray, an MRI scan, a blood test), be an appointment.

The database may comprise multiple types of data object. New instances of a data object (e.g. a new patient record) may inherit some or all of the properties of other data objects of the same type. For example, the workflow manager may be configured to associate a new instance of a data object with the same set of stakeholder objects and/or may set the permissions of a new instance of a data object such that the same set of actions can be run on the new instance as on the other data objects of the same type. In some implementations, a single definition may be stored for each type of data object defining the associations and permissions of data objects of that type: the data object instances of that type of data object may be considered to include that definition.

An example of the logical data content of a data object 700 is shown in FIG. 7. The data object includes information 701 about the object—for example, for a patient record data object this information might include the name, address, health system number and the medical records of the patient. Specification data 702 specifies the actions which can be performed on the object, which stakeholders can perform each of those actions, and optionally, in what context those actions can be performed.

Data objects and stakeholder objects as described herein may be any logical collections of data and may or may not be objects of a relational database. Data objects and stakeholder objects may be held in any manner at the computer system, including as one or more files or entries within files, or at a database.

A user of a computer terminal 206-208 is represented at database 203 as one or more corresponding stakeholders. A user terminal may be configured to authenticate a user (e.g. by requiring credentials from the user) so as to identify a profile stored for the user at the terminal or server. The computer system may be configured to associate each user profile with one or more stakeholder objects held at the database so as to allow the system to identify which stakeholders a user of a computer terminal represents, and hence the data and actions which may be presented to that user in accordance with the principles described herein. Each user profile may be stored in the database and linked to the one or more stakeholder objects representing the stakeholders associated with the user of that user profile.

A user is restricted by the workflow manager to accessing only those data objects associated with the stakeholder represented by the user. A user may access data objects at a user terminal in any suitable manner, including by browsing data objects, searching within data objects for data, or selecting data presented to them. The interface through which a user accesses their data may be configured to permit access in more than one way. As has been described, the user interface 213 may be configured according to the particular requirements of the stakeholder associated with the user.

Actions are defined in the database 203 as process definitions, each action being for operation on one or more data objects. An example of the logical data content of a process definition 800 defining an action is shown in FIG. 8. The process definition may include information about the action 801 (e.g. its name and other parameters), and procedural data 803 which defines the action itself—e.g. instructions defining the processing to be performed by the computer system, such as modifying, creating or deleting a data object, presenting a form to a user and enforcing the entry of mandatory information etc. Such procedural data could take any form, including, for example, data for interpretation at a processor of the server or client into a web application for presentation at the user interface, database operations, or any kind of program code suitable for execution at a processor of the server or user terminal.

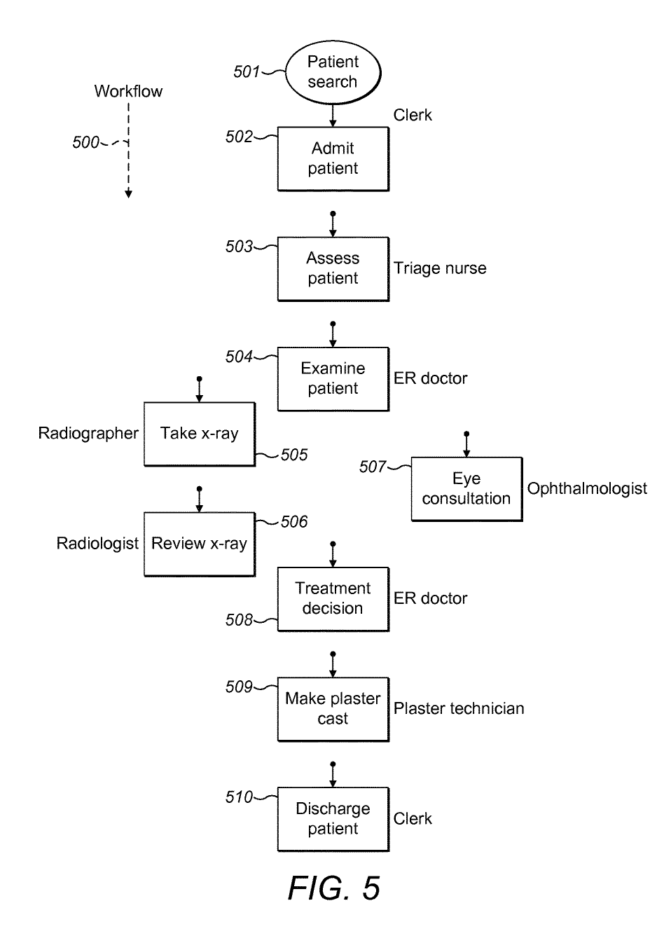

Through the sequential selection of actions by users of the system in the manner described herein, workflows may be performed in which each step is represented by one or more actions. For instance, in the hospital example described below with reference to FIG. 5, an action could be making an appointment for a patient through the computer system, performing a surgery on a patient (which may be reflected in the computer system through an action to update a data object representing the patient's record), or updating the address details of a patient. Each of these examples could be performed on a patient record data object.

A process definition may further comprise preconditions 802 which specify data (e.g. fields of a data object) which is to be used in the action from data objects on which the action is configured to operate. For example, in the example of updating the address of a patient record, preconditions for that action may copy certain data from a patient record data object on which the action operates into the fields of a form which is to be completed by a user performing the address update action.

Workflows which are possible in the hospital example could be, for instance, handling a patient from admission to discharge, booking an appointment for a patient in an outpatient clinic, or performing an X-Ray. A workflow may itself comprise many smaller workflows: for example, in a workflow relating to the handling of a patient from admission to discharge at a hospital, an X-Ray may be required, the performance of which may itself represent a workflow.

The actions defined in the database represent steps in one or more workflows. However, unlike in conventional systems, the actions are not linked in the system so as to define a workflow: the link between actions is provided by the stakeholders (e.g. a user authenticated as a stakeholder of the system) who progress a workflow by selecting an action presented at a computer terminal. By ensuring that a stakeholder is defined who can perform each action representing a step of workflow and that those stakeholders are associated with the data objects on which the actions are to be performed, a complete workflow can be achieved in an extremely flexible manner. At any point in a workflow, the next step is determined by a stakeholder of the system in the sense that any action available to that stakeholder can be performed on the data objects with which they are associated. Through appropriate definition of the data with which a stakeholder is associated and the actions which can be performed by that stakeholder, a set of possible workflows are established at the system. This arrangement allows the system to model complex business processes in a business or organisation which involve skilled workers who may be able to take a range of possible decisions within a workflow. The framework provided by the computer system nonetheless ensures that only certain personnel can perform a given action and that such an action must be performed in accordance with the requirements of the process definition defining that action (e.g. that certain data is provided, that certain checks are performed).

A workflow comprises a sequence of actions. However, the database 203 does not define a workflow as a particular sequence of actions and the process definitions are not linked so as to define a predefined sequence of actions in the database. For example, the system may not include any data linking actions into a sequence, or otherwise indicating that one action is to be performed before or after another. The workflows enforced by the system emerge from the particular structure of system and the definition of the data objects and stakeholder objects as appropriate to the environment modelled by the system (e.g. a hospital), and in particular the roles in that environment which are represented by the stakeholders (e.g. the hospital staff).

The operation of the system in performing a workflow will now be illustrated by way of example with reference to FIGS. 4, 5 and the system shown in FIG. 2.

Consider the workflow 500 shown in FIG. 5 which represents a possible sequence of actions performed in managing a patient from admission to discharge in a hospital. In this example, database 203 includes stakeholder objects representing hospital staff who are involved in performing workflows which are to be managed by the system. The stakeholder objects define at least a clerk, triage nurse, ER doctor, radiographer, radiologist, consultant and a plaster technician. There may be one or more members of the hospital staff representing each of these stakeholders. Each member of staff could be recognised by the system as being a particular stakeholder by means of the credentials with which they login to one of the terminals 206-208.

In this particular example, a person who has been injured in an accident is admitted into the emergency room by a clerk. The stakeholder object in database 203 defining a clerk allows the clerk to view all of the patient record data objects available at the system in database 203. For instance, the clerk may by means of a desktop terminal search the patient records 501 by name in order to locate the record for the injured person (hereafter the patient). An example of the user interface 213 of the terminal by means of which the search is performed is shown in FIG. 4. The clerk enters search parameters (such as the injured person's name or other information fields of the patient record data objects) into the search fields 401 and, in response, the workflow manager 205 returns a list of the data object matches 402. Typically only some of the information held in each patient record data object would be displayed at the user interface—for example, just the name and date of birth of each matching patient.

The clerk can then select the patient record of the injured person (e.g. record 404 in FIG. 4). On this selection being performed, the workflow manager 205 processes the selected patient record data object in order to determine which (if any) actions can be performed on that data object by the clerk. Any actions which are available to the clerk are presented as actions 403 in the user interface. Were the clerk to select more than one patient record, the clerk might be presented with other actions, such as ‘Merge patient records’ to allow duplicate records to be merged, or ‘Link records’ for linking in the system members of a family. When more than one record is selected the workflow manger could be configured to display those actions which operate on multiple records (as could be specified in the data objects or the process definitions) and are common to the displayed data objects. In other examples, the workflow manager could be configured to additionally or alternatively process the data objects which are presented to the user in order to determine which (if any) actions can be performed on that data object, prior to or irrespective of the selection of any particular data object(s) by the user. This can be useful for workflows in which an action is performed on a number of data objects at a time (e.g. all data objects returned by a search or presented at the user interface).

In this example, the clerk is presented with an action ‘Admit patient’. By selecting this action 502 the clerk is presented with an admission form defined in the process definition held at the database for that action. The admission form might require the clerk to enter information such as a description of which part of the body is injured, their pain level, whether the patient is conscious, etc. In this case, the patient has an injured arm and eye. The admission form would be defined at the procedural data for the ‘Admit patient’ action. The procedural data could define, for example, the appearance of the form, its data fields, which fields are mandatory and which optional, the required format of the data for each field, routines for processing data entered into the form, etc. Depending on the nature of the action, any processing associated with the action and defined in the procedural data could be performed at the processor of the server and/or of the user terminal. Typically, processing relating to the presentation and entry of data could be performed at the terminal, and any substantive processing relating to data held at database 203 could be performed at the server. Procedural data held at a process definition could include routines or code for execution at the terminal and/or server.

The process definition may further include a set of preconditions which define data required by the respective action. The preconditions specify to the workflow manager which data is to be used from the selected data object(s). For example, when the clerk selects the ‘Admit patient’ action, the workflow manager automatically copies data fields specified in the preconditions of that action from the selected patient data record into an admission record data object. In this example, the fields might include the name, health system number, date of birth and address of the patient, with the workflow manager populating the form with that data according to the preconditions of the action. The ‘Admit patient’ action generates a new instance of an admission record data object linked to the patient record data object. The admission record data object may be predefined in the database as a data object type. Once the action is complete and the admission record has been generated, the clerk's role in admitting the patient is complete.

Conventional workflow management systems do not allow a user to search or browse their data and, on the basis of the data viewed or selected, present to the user actions which can be run on that data by the user. In conventional systems, actions can only be run by selecting a case which has been pushed to a user in accordance with a strict workflow which is predefined at the system. The user would then start a predetermined action on that case, again according to the predefined workflow.

A second stakeholder in the system is a triage nurse. The triage nurse stakeholder is associated with admission records. When a triage nurse user searches or views admission records at a user interface 213 of a terminal, the triage nurse is provided with the action ‘Assess patient’ on selecting a patient who has not yet been assessed. This is achieved because the admission record data object processed by the workflow manager specifies that a triage nurse can perform the ‘Assess patient’ action on the data object only when the object information of the data object indicates that the patient has not yet been assessed. In other words, the action is presented only when a context specified in the selected data object is satisfied.

The triage nurse selects the admission record for the injured patient admitted by the clerk and runs the ‘Assess patient’ action 503. The triage nurse then assesses the patient, potentially aided by information presented at the terminal in accordance with the process, and determines the severity of the injuries. The triage nurse could also have access (through the stakeholder object with which the triage nurse as a system user is associated) to the patient record data objects. In this example, the injuries are not considered by the nurse to be life threatening so the nurse adds relevant notes to the admission record and selects a medium priority queue for treating the patient in the emergency room.

Note that the triage nurse does not perform the ‘Assess patient’ action on the admission record data object as a result of a predefined workflow specified in the database and performed by the workflow manager. The triage nurse performs the ‘Assess patient’ action on the admission record data object because the nurse views the data accessible to him or her, either by browsing or searching, and selects the action made available to him or her by the workflow manager. Thus, the database and workflow manager ensure that each user can only perform the actions available to them in accordance with the respective process definitions for those actions and the context in which the user views their data. In this manner, the system constrains users to perform only permitted workflows without being required to define those workflows in advance at the database.

An ER doctor next examines the patient, for example when the patient's admission record reaches the top of the queue displayed at the user interface of the doctor's terminal. ER doctors as a stakeholder are associated with admission record and patient record data objects. On selecting the admission record for the patient, the ER doctor is provided with the action ‘Examine patient’, which the doctor selects 504. This provides a form into which the doctor can make notes and also permits the doctor to view the patient's medical record (held in the object information of the patient record for the injured person) and the notes made by the triage nurse. Being a skilled worker, the ER doctor is not however led through a process defined for the ‘Examine patient’ action. The action represents the decision point at which the doctor freely determines the investigations to be performed on the patient and provides the doctor with the ability to order a range of investigations through the workflow management system (e.g. the procedural data for the action might provide a search interface at the terminal through which the doctor can request investigations, tests, scans and other procedures, and enter notes into the patient's medical record).

The doctor decides that an X-Ray of the patient's arm is required and that an ophthalmologist should take a look at the patient's eye. Selecting the appropriate options provided by the ‘Examine patient’ action causes the object information of the admission record to be modified to include the endorsements ‘X-ray required’ and ‘Ophthalmologist required’. The radiographer stakeholder could be configured to be provided with the action ‘Take X-Ray’ for admission records so endorsed which are viewed or selected by a radiographer user. The ophthalmologist stakeholder could be configured to be provided with the action ‘Eye consultation’ for admission records so endorsed which are viewed or selected by a radiographer user.

The user interface 213 of a terminal could be configured in dependence on the stakeholder with which the user of the terminal is associated. For example, on a radiographer logging into a terminal with their user credentials, the terminal could be configured to display a list of admission records which include the endorsement ‘X-ray required’. To give a second example, on an ophthalmologist logging into a terminal with their user credentials, the terminal could be configured to display a list of admission records which include the endorsement ‘Ophthalmologist required’. This could be achieved through the use of user profiles held at the system (e.g. at the database 203) for the users of the system which specify the stakeholder types with which each user is associated. By requiring a user of the system to authenticate themselves as a particular user (e.g. by logging in with their credentials), the system could load the appropriate user profile and hence the user interface associated with the associated stakeholder(s). The particular configuration of the user interface for a stakeholder could be stored in interface configuration data at the respective stakeholder object.

The radiographer selects the ‘Take X-Ray’ action 505 in respect of the patient's admission record which causes an X-Ray data object to be generated on which the ‘Take X-Ray’ action is performed. The X-Ray data object is linked to the patient's admission record. The resulting X-Ray image is stored in the X-Ray data object. A radiologist stakeholder is associated with all X-Ray data objects and hence can view the X-Ray data object linked to the patient's admission record. On selecting the X-Ray object, the radiologist is presented by the workflow manager operating on the X-Ray data object the action ‘Review X-Ray’. The radiologist selects this action 506 and enters their finding that the patient's arm is broken into a form presented by their terminal in accordance with the definition of the action in its respective process definition.

The ophthalmologist could similarly be able to run the ‘Eye consultation’ action 507 when selecting the patient's admission record. The ophthalmologist enters their finding that the eye has suffered only minor damage which needs no specific treatment into a form presented by the action and the notes are then stored in the admission record.

As each investigation is completed, the respective action could endorse the admission record so as to permit the ER doctor to determine when the investigations have completed. At that point, the ER doctor progresses the workflow by selecting the ‘Treatment decision’ action 508 on the patient's admission record. The doctor could determine when investigations have been completed by searching at their terminal for those records whose investigations are marked as completed by means of an appropriate endorsement (e.g. a flag or any other kind of indicator). The doctor can view the notes of the ophthalmologist and the X-Ray image linked to the admission record in the X-Ray data object. The doctor determines that the broken arm should be put into a plaster cast and so orders a forearm plaster cast from a list of treatments made available by the ‘Treatment decision’ action. This causes the admission record to be modified to show that a plaster cast is required.

A plaster technician uses a terminal which is configured to present all admission records which have been endorsed to show that a plaster cast is required. On the patient reaching the top of their work queue provided by the user interface at their terminal, the plaster technician selects that patient and is provided with the option to run the action ‘Make plaster cast’ 509. This action presents the plaster technician with the notes made by the doctor in the admission record identifying the type of cast required. The plaster technician makes the cast and marks the job complete in the action.

Finally the clerk can discharge the patient once all of the treatments requested by the doctor have been completed. This is achieved by configuring the admission record data object to cause the workflow manager to present to a clerk the action ‘Discharge patient’ 510 only when the clerk selects the admission record of a patient for which all of the requested treatments are marked as completed.

Such a complex workflow could not be achieved in conventional systems because the number of possible investigations and treatments is enormous and it would not be realistic to specify strict processes for every possible combination of investigations and treatments that a patient might require. Furthermore, because the computer system makes actions available to a user (a) according to the capabilities defined in the system for stakeholders to which the user belongs and (b) the context represented by the data to which that stakeholder has access, the system provides an architecture which ensures that workflows are appropriately performed.

For example, in order to enable a particular workflow to be performed, the stakeholder and data objects may be configured such that for each step of the workflow there is defined at least one stakeholder associated with the data objects on which that step is to be performed who is permitted to select the action representing that step. In order to prevent stakeholders from performing certain actions on their data, their data objects may be configured so as to not specify that the stakeholder can perform those actions. In order to prevent a stakeholder from accessing certain data objects, the stakeholder object representing that stakeholder may be configured so as to not specify those data objects as objects which the stakeholder can access.

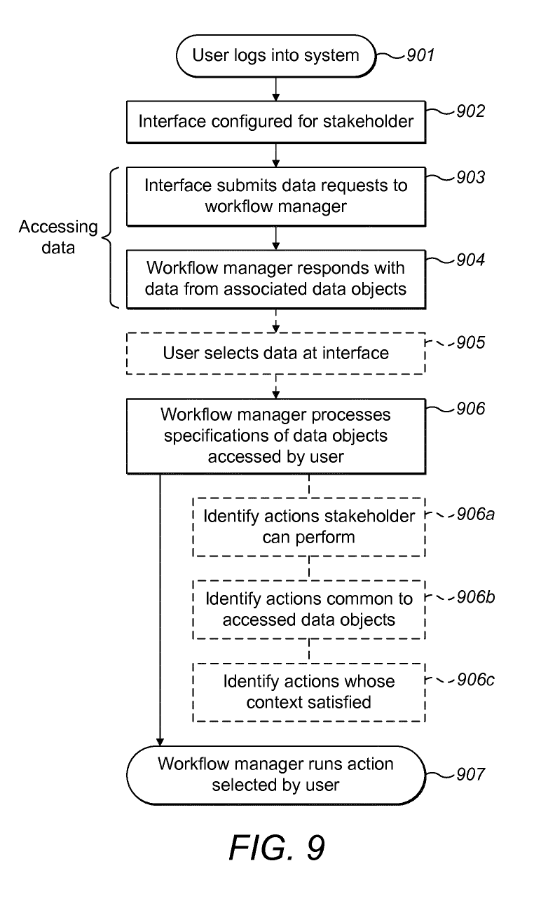

An example of the operation of the system shown in FIG. 2 when a user performs an action within a workflow will now be described with reference to FIG. 9. At 901, the user logs into the system at a user terminal, e.g. by entering their login credentials into a user interface 213 provided as a web application. The identity of the user could be verified at the user terminal 206 or the server 201. In this example, the workflow manager has access to a stored profile for each user which indicates to the system the stakeholder that the user represents. When the user logs into the system, the workflow therefore knows which stakeholder(s) the user represents and hence which stakeholder object(s) identify the data to which the user is to be permitted to access.

In response to the user logging into the system, at 902 the workflow manager running at processor 202 provides to the user terminal data stored at the user's profile or the associated stakeholder object which defines how the user interface 213 at the terminal should configured itself for that user (e.g. the appearance of the user interface, what search options should be presented, and whether the interface should attempt to load by default any data from the data objects associated with the stakeholder represented by the user).

At 903, the user submits a data request to the workflow manager by means of the user interface. For example: the user could browse their data, with the user interface being configured to request information from the workflow manager which satisfies the browsing performed by the user; or, the user could perform a search, with the search request entered into the user interface being passed to the workflow manager which performs the search within the data objects associated with the stakeholder represented by the user. The workflow manager satisfies the data requests received from the user interface (904) by returning the requested data from the data objects of the stakeholder represented by the user according to the associated data objects defined at the respective stakeholder object (e.g. 602 in stakeholder object 600 of FIG. 6). The user interface presents the returned data at the user interface. The workflow manager could be configured to return data restricted to the data objects of the stakeholder according to any suitable technique, such as by means of a suitable query into database 203 which holds the data objects (e.g. the query could include a list of the data objects/data object types which are identified by the stakeholder object).

Browsing data could include the user interface loading data by default on the user logging on to a terminal (e.g. in accordance with a data stored at the user's profile or at the associated stakeholder objects).

Steps 903 and 904 in the flowchart example represent a stakeholder (represented by the user) accessing their associated data objects. A stakeholder could alternatively or additionally access their data objects by selecting data presented to them (e.g. as the result of browsing or a search). This is indicated by flowchart step 905.

When a user accesses data at the user interface, whether through browsing, searching or selecting data presented at the interface, the user interface indicates to the workflow manager what data is being accessed. When browsing or searching, this information is naturally provided to the workflow manager in order to cause the workflow manager to return the appropriate data. When the user selects data presented to them at the user interface, the interface indicates to the workflow manager the data which is selected.

At 905, the workflow manager processes the specifications of the data objects at which the accessed data is held (e.g. 702 in the data object 700 shown in FIG. 7) in order to identify the set of actions which can be performed on those data objects and which the stakeholder represented by the user is permitted to perform. Such processing could be performed in any suitable manner. For example, the workflow manager could firstly filter the actions listed at the accessed data objects to identify a first set of actions which the stakeholder is permitted to perform (906a); the workflow manager could then filter the first set of actions to identify those actions which are common to all of the accessed data objects (906b) and hence generate a second set of actions (this step may not be required if only one data object is selected). The accessed data objects may further specify a context (e.g. a set of criteria as shown in 702) which must be satisfied in order for the action to be presented to the user. The workflow manager would therefore finally filter the second set of actions in order to identify a final set of actions (906c) whose context is satisfied by predefined criteria of the data objects (typically although not necessarily limited to the accessed data objects) for presentation to the user at the user interface in response to the accessing of data by the user. For instance, in the hospital example given above the patient data objects could additionally specify a ‘Register patient death’ action which any doctor (the stakeholder) can perform but which is only available to the doctor when selecting a patient record with has the criterion ‘IsDead’ set to true.

At 906, the user interface presents the final set of actions determined by the workflow manager to the user. Steps 903-906 can be repeated as the data accessed by the user changes so as to ensure that the user is always presented with an appropriate set of actions according to the data browsed, searched, selected or otherwise accessed by the user. At 907, the user selects an action presented at the user interface which causes the workflow manager to access the process definition stored for the action at the database and run the action according to the procedural data defining the action. This procedural data could, for example, define one or more of: a form the user is to complete; a set of checks to be performed against data entered by the user; a process to generate a new instance of a data object; a process to modify a data object. At least some of the procedural data could be run at the user terminal (e.g. this is where a form would be presented to the user for completion). The workflow manager could be configured to initiate an action with data from data objects held at the database according to preconditions present at the process definition for the action.

In this manner the users of the system are empowered to follow appropriate workflows without being overly constrained by predefined sequences of actions.

In the examples described herein, the data objects, stakeholder objects and actions are held in a database, but more generally such data could be provided anywhere accessible to the system and in any suitable form. The term object is to be understood as to not limit the database to being an object database; the term object is used broadly to refer to any collection of data having the information content described herein.

The computer system of FIG. 2 is shown as comprising a number of functional blocks. This is schematic only and is not intended to define a strict division between the different elements of the workflow management system. Each functional block can be provided in any suitable manner, including as fixed function hardware or as software running at a processor.

Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, System-on-chip, state machine, media processor, an application-specific integrated circuit (ASIC), a programmable logic array, a field-programmable gate array (FPGA), or the like. A computer or computer system may comprise one or more processors.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A computer system for enforcing a workflow, the computer system comprising:
a computer store comprising:
a set of actions;
a plurality of data objects each comprising a specification identifying one or more of the set of actions for operation on the data object; and
a plurality of stakeholder objects each being associated with (a) one or more of the data objects and (b) one or more of the set of actions;
a user terminal coupled to the computer store and configured to provide a user with access to one or more data objects associated with a stakeholder object corresponding to that user; and
a computer processor configured to perform at least part of a workflow comprising a sequence of first and second actions by:
operating a first action of the set on a first data object of the plurality;
in response to a first user accessing the first data object at the user terminal, causing the user terminal to present to the first user one or more second actions identified by the first data object and associated with a first stakeholder object corresponding to the first user; and
on the first user selecting a second action at the user terminal, operating the selected second action on the first data object.

2. A computer system as claimed in claim 1, wherein the first and second actions are not linked at the computer system so as to define the workflow.

3. A computer system as claimed in claim 1, wherein the computer processor is configured to:
in response to a second user accessing the first data object at the user terminal, cause the user terminal to present to the second user one or more first actions identified by the first data object and associated with a second stakeholder object corresponding to the second user; and operate said first action on the first data object in response to the second user selecting that first action at the user terminal.

4. A computer system as claimed in claim 1, wherein the computer system is configured to authenticate the first user at the user terminal and, in dependence on that authentication, identify the corresponding stakeholder object at the computer store.

5. A computer system as claimed in claim 1, wherein the computer store further comprises one or more user profiles each indicating a stakeholder object, the computer system being configured to identify the corresponding stakeholder object at the computer store by, in dependence on credentials provided by the user, looking up the user profile for that user and using the indicated stakeholder object as the corresponding stakeholder object.

6. A computer system as claimed in claim 1, wherein the access of the first data object by the first user at the user terminal comprises one or more of:
performing a search for information held at the first data object;
browsing information held at the first data object; and
selecting information held at the first data object and presented at the user terminal.

7. A computer system as claimed in claim 1, the computer processor being configured to present the one or more second actions at the user terminal as selectable options.

8. A computer system as claimed in claim 1, the computer processor being configured to perform the first and second actions on the first data objects in accordance with procedural data held at the respective actions.

9. (canceled)

10. A computer system as claimed in claim 1, wherein one or more of the plurality of data objects further include a context for one or more of the actions identified therein, each context defining a set of one or more characteristics of the respective data object required for triggering the action, and the computer processor being configured to present to the first user only those of the one or more second actions whose context is satisfied by the first data object.

11. A computer system as claimed in claim 1, wherein at least some of the set of actions include preconditions specifying information required by the action, and the computer processor being configured to automatically use in the selected second action the specified information as derived from the first data object.

12. A computer system as claimed in claim 1, the computer processor being configured to permit the first user to access only those one or more data objects associated with a stakeholder object corresponding to the first user.

13-15. (canceled)

16. A computer system for enforcing a workflow, comprising:
a database comprising:
stakeholder objects each specifying a set of data objects associated with a stakeholder; and
a plurality of data objects each having a specification identifying one or more predefined actions for operation on the data object and stakeholders permitted to initiate each of those actions;
a computer interface adapted for accessing the data objects; and
a computer processor is configured to:
in response to a stakeholder accessing one or more of their associated set of data objects, present actions at the computer interface for selection by a stakeholder in accordance with the specifications of the accessed data objects; and
in response to a stakeholder selecting one of the presented actions, perform that action on the accessed data objects.

17. A computer system as claimed in claim 16, the computer processor being configured to present said actions at the interface in response to the stakeholder accessing their associated set of data objects by one or more of:
performing a search at the interface for information held at their data objects;
browsing at the interface information held at their data objects; and
selecting information held at their data objects and presented at the interface; the accessed data objects being the data objects holding said information.

18. A computer system as claimed in claim 16, the computer processor being configured to present said actions in response to the stakeholder browsing information held at their data objects and selecting a subset of that information, said actions being identified by the computer processor in dependence on the selected information and not the unselected information.

19. A computer system as claimed in claim 16, each action including procedural data representing processes to be performed by the computer processor and the computer processor being further configured to perform the selected action on one or more of the accessed data objects in accordance with procedural data held at the action.

20-22. (canceled)

23. A computer system as claimed in claim 16, the specifications of the data objects and the stakeholder objects being configured such that a sequence of actions representing a workflow can be performed by stakeholders accessing their respective sets of data objects and initiating actions presented to them at the interface.

24. A computer system as claimed in claim 16, the specifications of one or more of the accessed data objects including a context for one or more of their identified actions, each context defining a set of one or more characteristics of the respective data object for triggering the action, and the computer processor being further configured to present to the stakeholder only those actions whose context is satisfied by the accessed data objects.

25. A computer system as claimed in claim 16, at least some of the actions including preconditions specifying information required by the action and held at the data objects, and the computer processor being configured to automatically use in an initiated action the specified information as derived from the accessed data objects.

26-31. (canceled)

32. A computer system as claimed in claim 16, the actions not being linked so as to predefine a workflow.

33. A computer system as claimed in claim 16, the system not defining workflows as predefined sequences of actions.

34. (canceled)

35. A computer system for enforcing a workflow, comprising:
a database that includes:
a plurality of stakeholder objects each defining a stakeholder and identifying data objects associated with that stakeholder;
a plurality of data objects each holding respective object information and identifying one or more actions for operation on the data object and the stakeholders permitted to select those actions; and
a plurality of actions for operation on the data objects;
an interface for providing a user of the system access to object information held at the data objects; and
a computer processor operable to perform the actions on the data objects and being configured to:
at the interface, allow the user to access object information held at those data objects associated with one or more stakeholders represented by the user; and
in response to the user accessing object information at the interface, present to the user actions which are identified at said those data objects as (a) being for operation on the subject data objects, and (b) which at least one of the one or more stakeholders represented by the user is permitted to select.

36-40. (canceled)
